(19) United States
(12) Patent Application Publication
(10) Pub. No.: US 2007/0273472 A1
(43) Pub. Date: Nov. 29, 2007

(54) Transmitter with adaptable display

(75) Inventor: Erlc Gregori, Lindenhurst, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 11/442,248

(22) Filed: May 26, 2006

(51) Int. Cl. B60R 25/00

(52) U.S. Cl. 340/5.7; 340/691.6; 340/5.71; 340/5.64; 340/5.25; 341/176

(57) ABSTRACT

At a transmitter being used in a moveable barrier operator system, a Liquid Crystal Display (LCD) is provided. The LCD is configured with a first visual display and the first visual display providing first information to a user. The LCD is selectively reconfigured with a second visual display and the second visual display providing second information to the user.

### FIELD OF THE INVENTION

The field of the invention relates to moveable barrier operators and, more specifically, to displaying information at transmitters that are used within these systems.

### BACKGROUND

Different types of moveable barrier operators have been sold over the years and these systems have been used to actuate various types of moveable barriers. For example, garage door operators have been used to move garage doors and gate operators have been used to open and close gates.

Such barrier movement operators may include a wall control unit, which is connected to send signals to a head unit thereby causing the head unit to open and close the barrier. In addition, these operators often include a receiver unit at the head unit to receive wireless transmissions from a hand-held code transmitter or from a keypad transmitter, which may be affixed to the outside of the area closed by the barrier or other structure. Besides moveable barriers, transmitters may also be used to actuate other types of electronic devices. For example, transmitters are used to activate or deactivate televisions, stereos, or video recorders.

Various types of information (e.g., relating to state, condition, operability, or some other characteristic) are often associated with the device. For example, a garage door operator may have information associated with it relating to the date and time it was last serviced. A swinging door may be currently open or closed. In addition, devices such as televisions, stereos, personal computers, and portable music players also have unique information associated with these devices relating to the operating characteristics of the device or the state of the device.

Users frequently move between different devices. Unfortunately, previous transmitters have not provided adaptable information displays that change as needed, for instance, as the transmitter moves between locations or devices. In one specific example, previous transmitters used in moveable barrier systems cannot adapt and display different configurations relating to different moveable barrier operators as the transmitter is moved between different moveable barrier operator systems. In these situations, since the transmitter is tied to one system or device, the user frequently has to carry multiple transmitters in order to actuate multiple devices and be able to view information related to these multiple devices. This leads to inconvenience and frustration for the user as they struggle to locate the correct transmitter to actuate the appropriate corresponding device.

### SUMMARY

A system and method are provided that allow for the adjustment of information presented to a user on a transmitter display (e.g., a liquid crystal display (LCD). The different information presented to the user may be related to different devices or different configurations of the same device. The adjustment may occur either as a result of manual input entered by the user or may be accomplished automatically. Consequently, the information presented to the user is always current and tailored to the needs of the user (e.g., the location of the user or the device for which the user desires to view information).

In accordance with the principles described herein, a display on a transmitter may be initially configured to display information concerning a first moveable barrier system. The transmitter may be either a portable transmitter or a transmitter that is fixed to a particular location. After moving to operate with a second movable barrier operator, the display may be reconfigured to provide information related to a second moveable barrier system.

In another example, the display may be initially configured to provide information related to a first device operating according to a first protocol. Subsequently, the display may be reconfigured to provide information related to a second device operating according to a second protocol.

In still another example, the display may be initially configured with information related to a first accessory device. Thereafter, the display may be reconfigured with information related to a second accessory device.

The information that is to be displayed may be received in a variety of different ways. For example, the information may be received via a radio interface. In another example, the information may be downloaded from a personal computer. In addition, the information may include a variety of different types of information. For instance, the information may include the state of a moveable barrier, the condition of a moveable barrier, the condition of a moveable barrier operator, or the condition of an accessory of a moveable barrier operator. Other examples of devices and types of information may also be displayed.

Reconfiguring the display may be initiated by a user utilizing the personal computer. In another example, reconfiguring of the display may be accomplished via the user actuating programming buttons on the transmitter, with the programming buttons being separate from the display. In another example, a touchscreen having soft keys may be provided and the display is reconfigured by using the soft keys on the display. In another approach, the transmitter may detect a signal emitted by a beacon. Reception of the beacon signal initiates the changing of the display.

The display can be used for other purposes as well. For example, one of the accessory items (e.g., the radio, television, stereo, video player, personal computer, music player, programming an accessory at least in part by using the display.

The display may present information about one or more devices/configurations at the same time. For example, the display may present information concerning a moveable barrier operator and an appliance to the user at the same time.

Thus, approaches are provided that allow a screen on a transmitter to be dynamically reconfigured to present various types of information to a user. These approaches provide a convenient and effective mechanism to provide multiple types of information concerning multiple devices to transmitter users.

### BRIEF DESCRIPTION OF THE DRAWINGS

FIG. 1 is a block diagram of a system for displaying information on a transmitter according to the present invention;

FIG. 2 is a diagram of a transmitter with a display according to the present invention;

FIG. 3 is a diagram of another example transmitter with a display according to the present invention;

FIG. 4 is a diagram of another example of a transmitter with a display according to the present invention;

FIG. 5 is a diagram of another example of a transmitter with a display according to the present invention; and

FIG. 6 is a block diagram of a transmitter with a display according to the present invention.

Skilled artisans will appreciate that elements in the figures are illustrated for ease of understanding and have not necessarily been drawn to scale. For example, the dimensions of some of the elements in the figures may be exaggerated relative to other elements to help to improve understanding of various embodiments of the present invention. Also, common but well-understood elements that are useful in a commercially feasible embodiment are often not depicted in order to facilitate a less obstructed view of the various embodiments of the present invention.

### DESCRIPTION

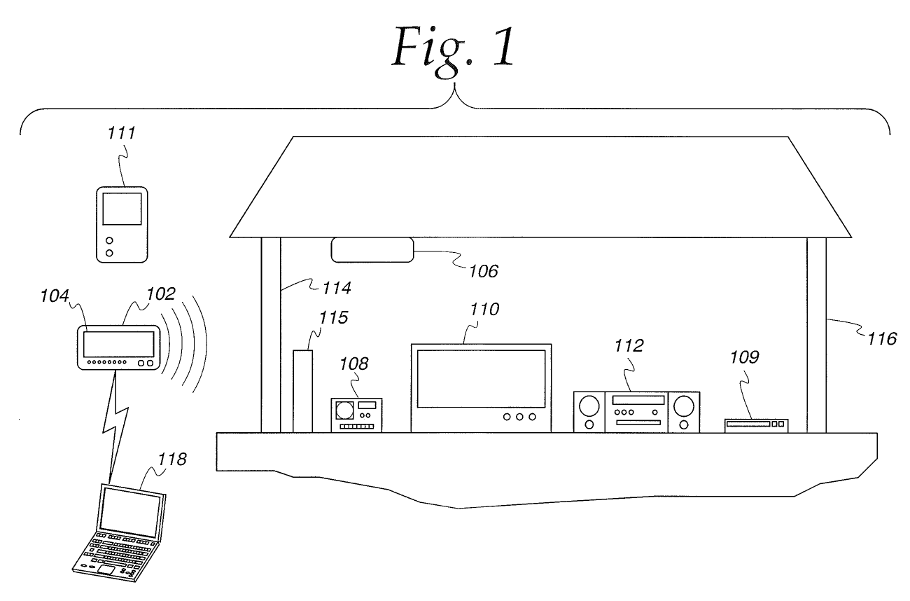

Referring now to the drawings and especially FIG. 1, one example of a system for presenting information on a display 104 of a transmitter 102 is described. The transmitter 102 is used to actuate a moveable barrier operator 106, which, in turn, is adapted to move a barrier 114. The moveable barrier operator 106 is positioned within a house 116 (i.e., the garage of the house 116). In addition to actuating the moveable barrier operator 106, the transmitter 102 may also be used to actuate a radio 108, a video player 109, a television 110, and a stereo 112. A personal computer 118 is also communicatively coupled to the transmitter 102 and may also be controlled by the transmitter 102. Alternatively, the personal computer 118 may be used to download information to the transmitter 102. Further, a portable music player 111 may be used and worn by a user.

As shown in FIG. 1, the moveable barrier operator 106 is a garage door operator. However, the moveable barrier operator 106 may be any type of moveable barrier operator such as a swinging gate operator or a sliding gate operator. In addition, although the barrier 114 is shown in FIG. 1 as being a garage door, the barrier 114 may be any type of barrier such as a swinging door, a swinging gate, or a sliding gate. Other examples of barrier operators and barriers are possible.

In addition, although the transmitter 102 is shown as being able to control the operator 106, the radio 108, the television 110, and the stereo 112, the transmitter 102 may control other types of devices and devices in other locations besides the devices and locations shown in FIG. 1. For example, the transmitter 102 may control other devices in the house 116 (e.g., kitchen appliances). Further, the transmitter 102 may control other moveable barrier operators at other locations. In still other examples, the transmitter may be used in conjunction with any other portable electronic device (cellular phones, pagers, personal digital assistants). Other examples of devices and other examples of locations where the controlled devices are positioned are possible.

The transmitter 102 may transmit a variety of different codes in order to actuate the various devices. In this regard, the transmitter 102 may send fixed codes or rolling codes to the devices. In another example, the transmitter 102 may send codes that change with every activation or with every predetermined numbers of activations.

The transmitter 102 may also transmit actuation signals at different frequencies depending upon the controlled device. For example, the transmitter 102 may transmit at a different frequency for a televison and at another frequency for a garage door opener. Consequently, when the display 104 is reconfigured to change displaying information concerning one device to display information for another device, the transmission frequency of the transmitter 102 may change. In other words, each transmission frequency may be associated with a separate display (or displays) at the transmitter 102. In still another example, a separate frequency may be associated with different types of devices (e.g., a first frequency for all garage door operators and a second frequency for all television sets) or groups of devices (e.g., a first frequency for all devices at a primary residence and a second frequency at a vacation home). Other examples of associating a transmission frequency or frequencies with different displays are possible.

Alternatively, the transmitter 102 may also transmit at the same frequency for different devices. For example, the transmitter 102 may transmit at the same frequency for all garage door operators and other devices that it actuates.

The display 104 may be any type of display, but in one preferred approach is a Liquid Crystal Display (LCD). The transmitter 102 is configured to present information to a user of the transmitter 102 on the display 104. The information may relate to a particular device or set of devices. Thereafter, the display 104 may be selectively reconfigured to display different types of information or new/updated information. The different or new information may relate to a different device or set of devices or may be updated information concerning the original device or set of devices. The reconfiguration may be caused by the receipt of user input (e.g., the user pressing a button) or may occur automatically (e.g., upon receipt of a beacon signal). As mentioned, when the transmitter moves from one device to another device (and the screen is reconfigured from displaying information about one device to displaying information about another device), the transmission frequency of the transmitter may change. The change of frequency may be caused by the receipt of the user input or the automatic indication (e.g., receipt of the beacon signal).

The information presented on the display 104 may include a variety of different types of information. For instance, the information may include a state of a moveable barrier, a condition of a moveable barrier, a condition of a moveable barrier operator, or a condition of an accessory of a moveable barrier operator. Other types of information from other devices may also be displayed.

The information may be received at the transmitter in a variety of different ways, for instance, the information may be received via a radio interface. In one example, a moveable barrier operator system may transmit information regarding its state and status to the transmitter using radio frequency (RF) signals. In another example, a wire or cable may be used to transmit the information to the transmitter from the moveable barrier operator system when the transmitter is a fixed keypad. In still another example, the information may be received from an intermediate device (e.g., a personal computer) where the information has been stored or entered.

In one example of reconfiguring the display, the display 104 may be initially configured to display information concerning a first moveable barrier system, for example, a movable barrier operator at the primary residence of the user. After moving to a second moveable barrier system (e.g., at the vacation home of the user), the display 104 may be reconfigured to provide information related to the moveable barrier system that is located at the vacation home of the user.

In another example, the display 104 may be initially configured to provide information related to a first device that is operating according to a first protocol. The display 104 may be reconfigured to provide information related to a second device that is operating according to a second protocol.

In still another example, the display 104 may be initially configured with display information related to a first accessory device (e.g. a television set). Subsequently, the display 104 may be reconfigured to provide information related to a second accessory device (a video player).

As mentioned, the reconfiguring of the display 104 may be accomplished via the user actuating programming buttons on the transmitter 102 where the programming buttons are separate from the display 104. In another example, the display 104 may be a touchscreen having soft keys and the display 104 may be reconfigured by actuating the soft keys.

In another example, a 115 may initiate the reconfiguring when the transmitter detects the presence of the beacon. The beacon 115 may emit an RF signal having a different frequency for different devices (e.g., a first frequency for a first garage door opener system and a second frequency for a second garage door opener system). In another example, the beacon may emit a transmission with a code word that is unique for a particular device (e.g., a first code word for a first garage door opener system and a second code word for a second garage door opener system). Other examples of beacons are possible.

Besides displaying information about a device, the display 104 can be used for other purposes as well. For example, when the display 104 is a touch screen, soft keys on the touch screen may be used to actuate and/or program the device.

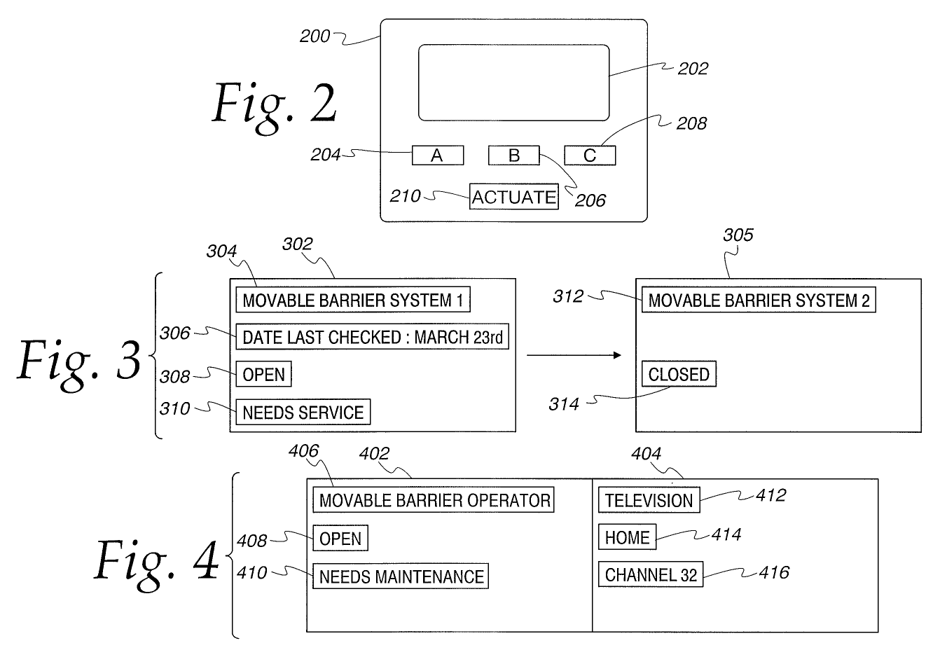

Referring for FIG. 2, one example of a transmitter 200 is described. The transmitter 200 includes a display 202 (e.g., a LCD), configuration buttons 204, 206, and 208, and an actuation button 210. In addition, other buttons may be included such as learning mode buttons to provide other types of functionality.

The display 202 presents various information in varying formats as the display changes configurations. In addition, the display 202 may present information concerning multiple devices.

The buttons 204, 206, and 208 are used to adjust the configuration and display information concerning the various devices. For instance, pressing each of the buttons may cause the display of information related to a different moveable barrier operator. In another example, pushing each button may present information relating to a different device (e.g., a barrier operator, a television, and a portable music player).

The button 210 is used to actuate devices. For example, the button 210 may be used to open and close a moveable barrier. Alternatively, the button 210 may be removed and, if the display 202 is a touch screen, a soft key on the touch screen may be used for the actuation functions.

Referring now to FIG. 3, one example of a screen used in conjunction with a transmitter is described. A first screen 302 is presented to a user when the transmitter is operating with a first movable operator system. As shown, the screen 302 includes system identification information 304 (“moveable barrier system 1”), maintenance information 306 (“date last checked: March 23”), state information 308 (“open”), and other messages 310 (“needs service”).

A second screen 305 includes system identification information 312 (“moveable barrier system 2”), and state information 314 (“closed”). The display may be changed from screen 302 to screen 305 (or vice versa) by pressing a dedicated button, pressing a soft key on the screen, or having some external device (e.g., a beacon) initiate the changing. Other examples approaches for changing the display are possible.

Referring now to FIG. 4, another example of a screen 400 used in conjunction with a transmitter is described. This example shows that the screen has been partitioned into multiple portions 402 and 404. Each of these portions may be updated or change or one may always be present. For the screen 402, a system identification portion 406 identifies the system (“moveable barrier operator”), a status section 408 identifies the status (“open”), and a maintenance section 410 identifies the status (“needs maintenance”).

For the portion 404, a system identification portion 412 identifies the system (“television”), a location section 414 identifies the location of the device (“home”), and a channel identification section 416 identifies the channel the television is tuned (“channel 32”).

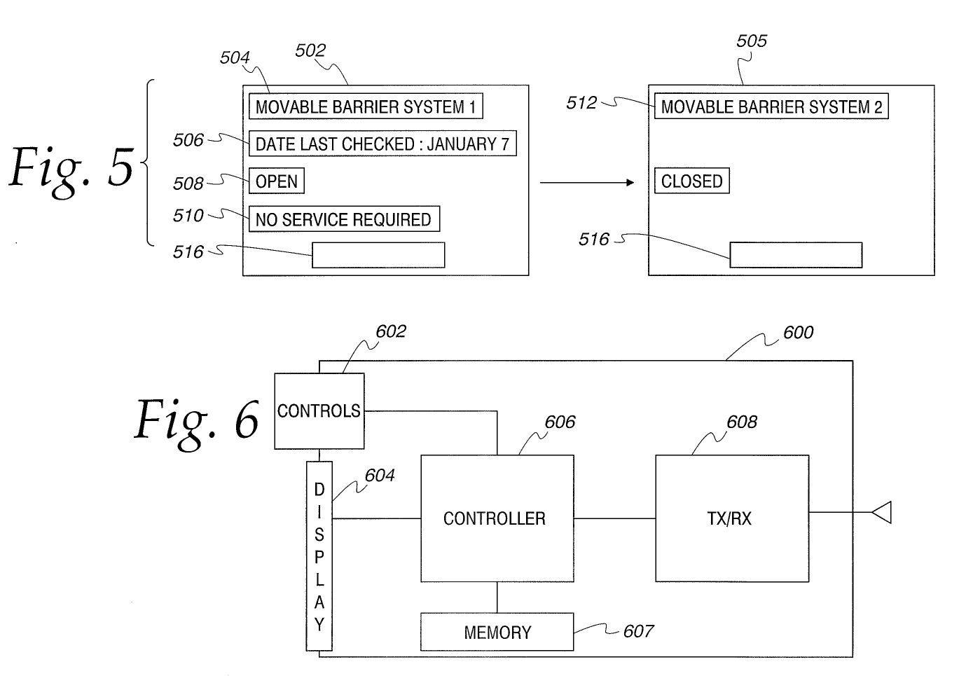

Referring now to FIG. 5, another example of a screen that is used in conjunction with a transmitter is described. A first screen 502 is presented to a user when the transmitter is operating with a first movable operator system. As shown, the screen 502 includes system identification information 504 (“moveable barrier system 1”), maintenance information 506 (“date last checked: January 7”), state information 508 (“open”), and other messages 510 (“No service required”).

A second screen 505 includes system identification information 512 (“moveable barrier system 2”), and state information 514 (“closed”). The screens 502 and 505 may be changed by pressing a soft key 516 on the screens 502 or 505. In one example, the user, upon arrival in the location of the first moveable barrier operator, may press the soft key 516 on the display. Thereafter, when the user arrives in the vicinity of the second movable barrier operator, they may again press the soft key 516 and the screen 505 appears.

Referring now to FIG. 6, another example of a transmitter is described. The transmitter 600 includes a controller 606. The controller 606 is coupled to transmitter/receiver 608 and a display 604 (e.g., a LCD). The controller 606 is also coupled to and receives display reconfiguration commands from controls 602 (e.g., buttons).

The controller 606 is programmed to initially provide first information on the display 604. When the controller 606 receives a reconfiguration commands from the controls 602, the controller 606 responsively replaces the first information on the display 604 with second information. For instance, pushing a first button may cause the controller 606 to display information associated with a first moveable barrier operator while pressing a second button may cause the controller 606 to display second information associated with a second moveable barrier operator. The information displayed may be stored in the transmitter in a memory 607.

The information that is to be displayed may be received from a number of different sources. For example, an external device (e.g., a moveable barrier operator, an appliance, or an accessory device) may transmit information to be displayed to the transmitter 600. In another approach, a personal computer may be used to download the information (either using a cable or via RF signals). Whatever the source or method of transmission to the transmitter, the information may be received at the transmitter/receiver 608 and stored in the memory 607 for future display. This updated information may be received at regular intervals or whenever the transmitter 600 is near the corresponding device. Other approaches for updating the display information are possible.

Information related to different devices may be presented on the display 604. For example, information related to a first moveable barrier system and information related to a second moveable barrier system may be alternately presented on the display 604. In another example, information may be related to a first device operating according to a first protocol and second information related to a second device operating according to a second protocol may be alternately presented. In still another example, first information related to a first accessory device and the second information related to a second accessory device may be presented on the display 604.

Different types of information related to a particular device may also be presented on the display 604. For example, the information to be presented on the display 604 may be the state of a moveable barrier, the condition of a moveable barrier, the condition of a moveable barrier operator, or the condition of an accessory of a moveable barrier operator. Other examples of devices and information related to these devices may also be displayed.

As mentioned, the controls 602 may be buttons with each button dedicated to a different device configuration that may be displayed when the button is pressed. Alternatively, the controls 602 may be omitted and replaced with soft keys on the display 604. Other approaches for initiating the reconfiguring of the display 604 are possible.

Thus, approaches are provided that allow a display on a transmitter to be dynamically reconfigured to show various types of information related to different types of devices. These approaches conveniently present different displays with different information to users depending upon the type of device for which a display is needed, the location of the user, or other factors.

While there has been illustrated and described particular embodiments of the present invention, it will be appreciated that numerous changes and modifications will occur those skilled in the art, and it is intended in the appended claims to cover all those changes and modifications which fall within the true scope of the present invention.

What is claimed is:

1. A method of providing a programmable interface for a moveable barrier operator system comprising:
at a transmitter being used in a moveable barrier operator system:
providing a Liquid Crystal Display (LCD);
configuring the LCD with a first visual display, the first visual display providing first information to a user; and
selectively reconfiguring the LCD with a second visual display, the second visual display providing second information to the user.

2. The method of claim 1 wherein configuring the LCD with first information comprises providing information related to a first moveable barrier system and wherein reconfiguring the LCD comprises providing second information related to a second moveable barrier system.

3. The method of claim 1 wherein configuring the LCD with first information comprises providing first information related to a first device operating according to a first protocol and wherein reconfiguring the LCD with second information comprises providing second information related to a second device operating according to a second protocol.

4. The method of claim 1 wherein configuring the LCD with first information comprises providing first information related to a first accessory device and wherein reconfiguring the LCD with second information comprises providing second information related to a second accessory device.

5. The method of claim 1 further comprising receiving the first and second information via a radio interface.

6. The method of claim 5 wherein receiving the first and second information comprises receiving the first and second information, the first and second information being selected from a group comprising: a state of a moveable barrier; a condition of a moveable barrier; a condition of a moveable barrier operator; and a condition of an accessory of a moveable barrier operator.

7. The method of claim 1 wherein selectively reconfiguring the LCD is initiated via a user utilizing a personal computer.

8. The method of claim 1 wherein selectively reconfiguring the LCD is accomplished via a user actuating programming buttons on the transmitter, the programming buttons being separate from the LCD.

9. The method of claim 1 wherein selectively reconfiguring the LCD is accomplished in response to the reception of signals from a beacon.

10. The method of claim 1 wherein providing the LCD comprises providing a touchscreen having soft keys and wherein reconfiguring the LCD comprises reconfiguring the LCD by using the soft keys on the LCD.

11. The method of claim 1 comprising programming an accessory at least in part by using the LCD.

12. The method of claim 11 wherein the accessory is selected from a group comprising a music player, a video player, a radio, and a personal computer.

13. An transmitter for use with moveable barrier operator systems comprising:
a liquid crystal display (LCD);
an interface for receiving commands from a user; and
a controller coupled to the LCD and the interface, the controller programmed to provide first information on the LCD, the controller programmed to receive a reconfiguration command from the interface and to responsively replace the first information with second information.

14. The transmitter of claim 13 wherein the first information comprises information related to a first moveable barrier system and wherein the second information comprises information related to a second moveable barrier system.

15. The transmitter of claim 13 wherein the first information comprises information related to a first device operating according to a first protocol and wherein the second information comprises information related to a second device operating according to a second protocol.

16. The transmitter of claim 13 wherein the first information comprises information related to a first accessory device and wherein the second information comprises information related to a second accessory device.

17. The transmitter of claim 13 wherein the first and second information is received at the transmitter via a radio link.

18. The transmitter of claim 13 wherein the first and second information is selected from a group comprising: a state of a moveable barrier; a condition of a moveable barrier; a condition of a moveable barrier operator; and a condition of an accessory of a moveable barrier operator.

19. The transmitter of claim 13 wherein the interface is coupled to a personal computer.

20. The transmitter of claim 13 wherein the interface comprises an actuator, the actuator being separate from the LCD.

21. The transmitter of claim 13 wherein interface comprises soft keys on the LCD.

22. A system for actuating moveable barrier operators comprising:
a first moveable barrier operator;
a transmitter communicatively coupled to the first moveable barrier operator and comprising a liquid crystal display (LCD) and an interface for receiving commands from a user, the transmitter receiving first information and displaying the first information on the LCD, the transmitter being reconfigurable to replace the first information with second information.

23. The system of claim 22 wherein the first information comprises information related to the first moveable barrier operator and wherein the second information comprises information related to a second moveable barrier operator.

24. The system of claim 22 wherein the first information comprises information related to a first device operating according to a first protocol and wherein the second information comprises information related to a second device operating according to a second protocol.

25. The system of claim 22 wherein the first information comprises information related to a first accessory device and wherein the second information comprises information related to a second accessory device.

26. The system of claim 22 wherein the transmitter receives the first and second information via a radio link.

27. The system of claim 22 wherein the first and second information is selected from a group comprising: a state of a moveable barrier; a condition of a moveable barrier; a condition of the first moveable barrier operator; and a condition of an accessory of the first moveable barrier operator.

28. The system of claim 22 further comprising a personal computer to program the transmitter.

29. The system of claim 22 wherein the interface comprises at least one actuator, the actuator being used to initiate reconfiguring the LCD.

30. The system of claim 22 wherein the interface is associated with the LCD and comprises soft keys and wherein the soft keys are used to initiate the reconfiguring of the LCD.

31. The system of claim 22 comprising a beacon for transmitting a signal to the transmitter, the reception of the signal at the transmitter initiating presentation of the first information on the LCD.
